(19) United States
(12) Patent Application Publication
(10) Pub. No.: US 2025/0353430 A1
(43) Pub. Date: Nov. 20, 2025

(54) ENCHANCED OPTICAL EMERGENCY SIGNALING AND COMMUNICATIONS FOR TRAILERS

(71) Applicant: ESS-HELP, INC., Houston, TX (US)

(72) Inventors: DAVID M. TUCKER, Katy, TX (US); Robert H. Orlean, Houston, TX (US); Timothy R. VanGoethem, Milford, MI (US); STEPHEN T. POWERS, Houston, TX (US)

(21) Appl. No.: 19/212,092

(22) Filed: May 19, 2025

Related U.S. Application Data
(60) Provisional application No. 63/648,702, filed on May 17, 2024.

(51) Int. Cl. B60Q 1/52; B60D 1/62; B60Q 1/00

(52) U.S. Cl. CPC B60Q 1/52; B60D 1/62; B60Q 1/0088

(57) ABSTRACT

A system for a trailer has an interface to a tow vehicle that provides power and activation signals corresponding to a plurality of lights on the trailer including at least signal and hazard lights and an interface to the trailer that provides operative control over the plurality of trailer lights. A microcontroller receives at least the activation signals from the interface to the tow vehicle and operatively controls the plurality of trailer lights via the interface to the trailer. The microcontroller strobes one or more of the plurality of trailer lights at a rate perceptible faster than a rate at which the microcontroller flashes a signal light in response to a strobe signal.

### CROSS-REFERENCE TO RELATED CASES

This application claims the benefit of U.S. provisional patent application Ser. No. 63/648,702, filed on May 17, 2024, and incorporates such provisional application by reference into this disclosure as if fully set out at this point.

### FIELD OF THE INVENTION

This disclosure relates to vehicle lighting in general and, more specifically, to emergency lighting and optical communication systems for trailers.

### BACKGROUND OF THE INVENTION

Enhanced lighting communication systems for use in emergencies and possibly other situations are available for passenger cars, commercial vehicles, and others. However, less attention has been paid to enhanced lighting systems for trailers apart from the towing vehicle.

What is needed is a system and method for addressing the above and related issues.

### SUMMARY OF THE INVENTION

The invention of the present disclosure, in one aspect thereof, a system for a trailer that includes a microcontroller having a communicative coupling to a tow vehicle that receives light activation signals from the tow vehicle corresponding to a plurality of lights on the trailer including at least signal and hazard lights. The microcontroller has operative control over the plurality of trailer lights, the microcontroller strobes at least the hazard lights in response to a hazard light activation signal from the tow vehicle, and the strobing operation is perceptibly faster than a flashing operation that corresponds to operation of signal lights.

In some embodiments, the hazard lights comprise left and right signal lights on at least a rear of the trailer. When the microcontroller strobes at least the hazard lights, it may also strobe additional ones of the plurality of lights on the trailer.

The invention of the present disclosure, in another aspect thereof, comprises a system for a trailer including an interface to a tow vehicle that provides power and activation signals corresponding to a plurality of lights on the trailer including at least signal and hazard lights, an interface to the trailer that provides operative control over the plurality of trailer lights, and a microcontroller that receives at least the activation signals from the interface to the tow vehicle and operatively controls the plurality of trailer lights via the interface to the trailer. The microcontroller strobes one or more of the plurality of trailer lights at a rate perceptible faster than a rate at which the microcontroller flashes a signal light in response to a strobe signal.

In various embodiments, the strobe signal: is received from the tow vehicle; comprises a signal to activate left and right signal lights; is provided by an automated vehicle emergency system; is provided by a self-driving system; and/or is received wirelessly.

In some cases, the one or more of the plurality of trailer lights that is strobed includes the signal and hazard lights. In some cases the one or more of the plurality of trailer lights that is strobed includes trailer lights in addition to the signal and hazard lights. In some embodiments, the microcontroller does not strobe the one or more of the plurality of trailer lights when a nuisance signal is also received.

The microcontroller may be communicatively coupled to a telematics system for receiving the strobe signal. The system may further comprise a housing affixed to the trailer or towing vehicle and containing the microcontroller. The system may include a battery backup system connected to power at least the microcontroller. The interface to the tow vehicle may comprise a first ISO1724 interface. The interface to the trailer may comprises a second ISO1724 interface.

The invention of the present disclosure, in another aspect thereof, comprises a system for a trailer including an interface to a tow vehicle that provides activation signals corresponding to a plurality of lights on the trailer including at least left and right signal lights, an interface to the trailer that provides operative control over the plurality of trailer lights, and control logic that receives the activation signals from the interface to the tow vehicle and operatively controls the plurality of trailer lights via the interface to the trailer. The control logic flashes the left signal light when receiving a left signal light activation signal and flashes the right signal light when receiving a right signal light activation signal. The control logic strobes the left signal light and the right signal light simultaneously when the control logic receives a strobing activation signal. The strobe rate is perceptibly faster than the left signal light rate and the right signal light rate.

In some cases, the strobing activation signal comprises a hazard light activation signal. In other cases, the strobing activation signal comprises a signal distinct from a hazard light activation signal.

The system may further comprise a battery backup that operates the control logic and the left and right signal lights when insufficient power is received from the interface to the tow vehicle.

When the control logic strobes the left signal light and the right signal light simultaneously it may also strobe additional ones of the plurality of lights on the trailer.

In some embodiments corresponding to the systems above, the strobing or enhanced conspicuity operations operation include a left-to-right or right-to-left directional pattern among trailer lights to indicate hazard positioning. In some cases, the microcontroller activates the strobing or enhanced conspicuity operation only when GPS data indicates the trailer is stationary and located on or near a public roadway. Strobing or enhanced conspicuity is triggered in response to accelerometer-detected deceleration exceeding a predetermined threshold. The systems may include a user interface on a mobile device configured to manually activate or disable strobing behavior wirelessly.

In some embodiments corresponding to the systems above, the microcontroller strobes one or more additional trailer lights selected from the group comprising: brake lamps, clearance lamps, side marker lamps, and rear identification lamps. The microcontroller may strobe the brake lamps at a different frequency than the hazard lights to convey an emergency braking condition.

### BRIEF DESCRIPTION OF THE DRAWINGS

FIG. 1 is a perspective view of an emergency lighting and optical communication systems for trailers within a resilient housing according to aspects of the present disclosure.

FIG. 2 is a diagrammatic view of an installation of an emergency lighting and optical communication system of the present disclosure.

FIG. 3 is a schematic diagram of an emergency lighting and optical communication system according to aspects of the present disclosure.

FIG. 4 is a rear perspective view of a tractor-trailer illustrating potential placement of trailer lighting.

FIG. 5 is a simplified control schematic of an emergency lighting an optical communication system according to the present disclosure interfaced to a semi tractor for controlling trailer lighting.

### DETAILED DESCRIPTION OF THE PREFERRED EMBODIMENTS

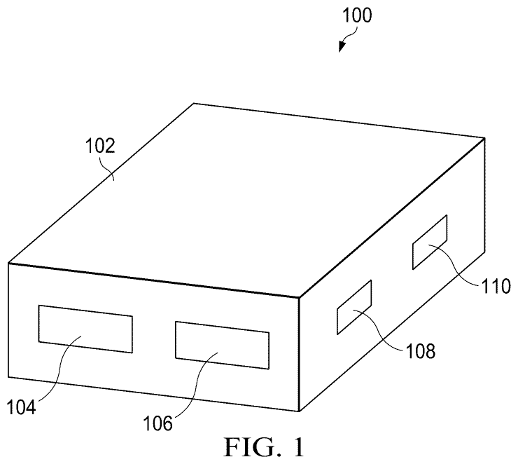

Referring now to FIG. 1, a perspective view of one embodiment of an emergency lighting and optical communication system 100 for trailers within a resilient housing according to aspects of the present disclosure. Hardware corresponding to systems 100 and methods of the present disclosure may be located in a resilient box 102, which may be metallic or non-metallic. The resilient box 102 may be placed in a suitable location somewhere in/on the trailer or towed vehicle, possibly in a protected location to reduce the chance of physical damage. The enclosure or box 102 may be manufactured to IP67 or equivalent standards, or may be manufactured or configured to meet other applicable industry standards.

The system 100 may provide a tractor light source interface 104 that allows the system to receive a connection from a tractor or semi truck that carries power, signals, and/or information relating to operation of the trailer lights as commanded by the truck or tractor. Commands or signal include, without limitation, marker lights, brake lights, and turn signals as are known to the art to be sent to the trailer from the semi truck. Existing ISO1724 tractor harness and trailer connector interface is used in some embodiments to avoid custom harnesses or cutting/splicing into wiring. However, other standard connections and custom or proprietary connections are usable with embodiments of the present disclosure so long as the appropriate signals or leads are provided. For example, the connection from the tractor may be made in addition to the standard tractor trailer wiring connection. In such cases, the tractor wiring output may be jumpered to provide input. Output can also be duplicated via additional wiring to the trailer and/or combining leads.

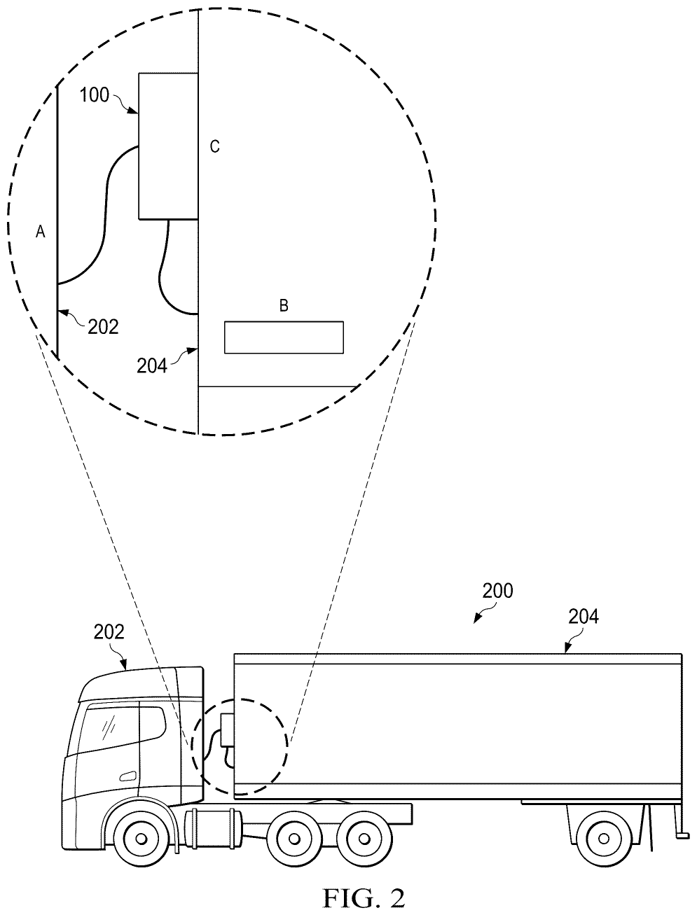

A trailer light load interface 106 is also provided by the system 100. This interface is connected to the trailer wiring to the trailer lights (e.g., FIG. 2). Here again, an existing ISO1724 interface to the trailer may be utilized to minimize installation time and materials. Utilizing an existing interface already installed on the trailer may allow for easy retrofitting to an existing trailer. However, in other embodiments, the system 100 is wired directly to the trailer lighting (e.g., without going through a separate defined interface). This may present the most economical solution with a trailer that is equipped to implement systems and methods of the present disclosure as an OEM product.

The system 100 may provide a separate arming switch interface 108. This may provide an electronic connection to another system or device capable of arming the system 100. In other embodiments, the system 100 is armed or powered up directly with a physical switch at this location. The system 100 may also interface with a telematics system to send or receive data. A telematics interface 110 may thus be provided, and can be any suitable interface known to the art.

Referring now to FIG. 2, a diagrammatic view of an installation of an emergency lighting and optical communication system of the present disclosure 100 on a semi tractor-trailer 200 is shown. Here a semi tractor 202 is shown with an attached trailer 204 equipped with a lighting system 100 according to the present disclosure. In some cases, the physical box or housing for such box may be located toward a front of the trailer 204 for ease of connection. This may be referred to as a “nose box”. As shown, the system 100 is installed at a forward or nose location C to also be close to the tractor pig tail or other connection at A. The system 100 is also close by to existing telematics system at B for ease of interconnection. It should be understood that the hardware corresponding to the system 100 can be installed elsewhere on the trailer 204 for ease of manufacture, ease of after market installation, and/or security issues, though this may involve additionally wiring or longer interconnection leads to the truck 202 or other devices. In other embodiments, the system 100 may be installed on or in, or mounted to, the tractor 202. In such configuration, the system 100 still adds functionality to the trailer but may travel or move with the tractor 202 as various trailers are used over time.

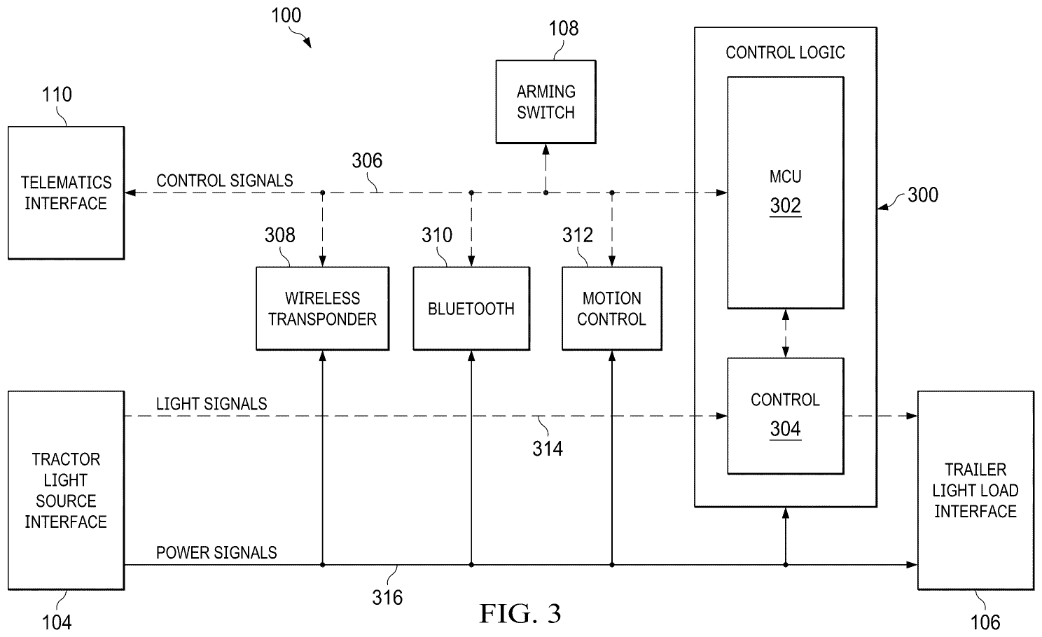

Referring now to FIG. 3, a schematic diagram of an emergency lighting and optical communication system according to aspects of the present disclosure is shown. As seen in FIG. 3, the system 100 may be based on a control logic set 300. The control logic 300 may comprise a microcontroller unit 302. In other embodiments, a microprocessor, a microcontroller, a system-on-a-chip, an application specific integrated circuit (ASIC), a programmable gate array, and/or a suitable analog control circuit may be used in addition to or instead of a microcontroller. The device utilized should be capable of being programmed or designed by one of skill in the art to implement the operations described herein. It may comprise any hardware capable of being appropriately configured or programmed to carry out the described control and functionality. Wireless communication modules, signal conditioning circuitry, power backup, wired interfaces, and combinations of these or other components known to the art that can be used to implement systems and methods of the present disclosure may be employed.

In some embodiments, a separate light controller 304 is utilized by the microcontroller 302 to implement light switching and activation/deactivation. The light controller 304 may be a digital or analog device(s) as known to the art. In some embodiments, the light activation/deactivation functionality is integrated directly into the microcontroller 302.

In some embodiments, a control bus 306 interconnects the microcontroller 302 with the telematics interface 110 or the arming switch connection 108. Internally, the system 100 may also provider a wireless transponder 308, a Bluetooth® interface 310, and/or a motion control device 312. Light signals may be received on the signal bus 314 from the tractor light source interface 104. The signal bus 314 may connect to the light controller 304 which is interface to the microcontroller 302. In other embodiments, the signal bus 314 may be interfaced directly to the microcontroller 302 instead of, or in addition to, the light controller 304. Buses and signal lines may be implemented using any appropriate standard, protocol, or method known or devised by one of skill in the art.

Power or power signals may come from the tractor light source interface 104 to the wireless transponder 308, the Bluetooth® interface 310, the motion control device 312, the light controller 304, and/or the microcontroller 302 via a power bus 316. Power and power signals may also be provided to the trailer lights via the trailer light load interface 106 from the power bus 316. In some embodiments, the necessary power and power signals for the trailer lights comes directly from the light controller 304 or the microcontroller 302.

Existing telematics systems (if available) may be interfaced with the system 100 for purposes of generating alerts via the telematic interface 110. Alerts or operations coming from the telematics interface 110 are handled via the microcontroller 302. Systems of the present disclosure may utilize generated alerts or information contained (from the telematic interface 110) therein as a basis of activating enhanced conspicuity lighting. In some embodiments, systems of the present disclosure are designed to interface with systems such as those designed by Emergency Safety Solutions of Houston, Texas or similar that may be present on the tow vehicle.

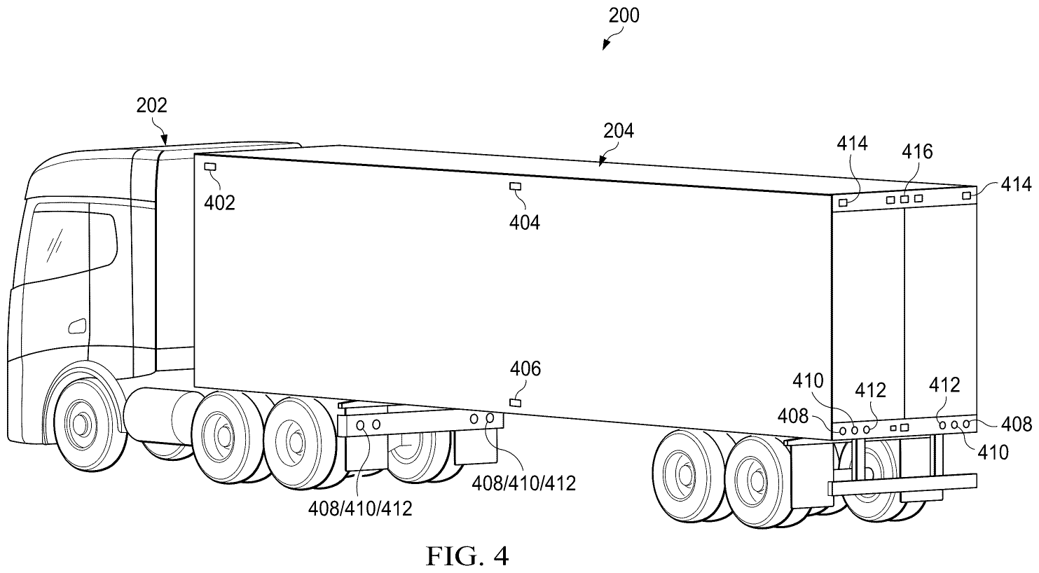

Referring now to FIG. 4, a rear perspective view of a tractor-trailer 200 illustrating potential placement of trailer lighting. In the US, trailer lighting requirements for interstate commercial operation are governed by Title 49 Code of Federal Regulations § 393.11. Other regulations may also apply and this does not account for state specific regulations. Additionally, European and other regulatory bodies have different requirements. Thus, FIG. 4 is exemplary only. Systems and methods of the present disclosure may be readily adapted by one of skill in the art to enhance operation of lighting in any configuration. Moreover, some jurisdictions have regulations with respect to enhanced operation of lighting, and when it can be employed. Those familiar with the operational jurisdiction of a specific trailer may implement systems and methods of the present disclosure in a way that complies with laws and regulations based on the disclosure provided herein, and the specific examples provided.

Apart from the lighting required for the towing vehicle or tractor, a trailer may be equipped with at least front (left and right) side marker lamps 402. These may be illuminated in a steady state when the vehicle is parked or operated. They may also be operated in an enhanced manner as described herein. Similarly, some trailers are equipped with intermediate side marker lamps 404 (left and right) that may be illuminated in a steady state, or may be flashed with signal lights. For purposes of the present disclosure, light and lamps are used interchangeably. The technology most commonly deployed in newer trailers would be light emitting diodes (LEDs). LEDs also allow for faster or enhanced conspicuity operations as described in the present disclosure. However, where trailer lights or lamps are based on older incandescent technology, the lights may be retrofitted or upgraded to LED to take advantage of the technology described herein.

At the rear of the trailer 204 may be a number of different lights. For example, signal lights 408, stop lamps 410, and tail lamps 412 may be provided. In some instances, the functions of these lights are combined. For example, some trailers utilize a single lamp for turn signaling and braking indication. It is possible to combine all three functions into a single lamp (e.g., tail lamp, signal light, and braking indicator) but regulations may require multiple lamps (for example, in the US, at least two lamps are required to fulfill these functions). It should be understood that the signal lamps 408 are generally also utilized as emergency or hazard flashers. In some embodiments of the present disclosure, it is the hazard flashers in particular that are operated in a faster or high conspicuity fashion. Other embodiments may employ different or additional trailer lamps in a high conspicuity fashion to indicate hazards.

The trailer 204 may also have rear identification lamps 416, which indicate the vehicle is 80 inches or wider in the US. Clearance lamps 414 may also indicate the widest point of the rear of the trailer 204. It should be appreciated that more or fewer lights than illustrated may be utilized or required based on the type and size of trailer. The technology of the present disclosure is easily adapted by one of skill in the art to additional trailer lighting configurations.

Various embodiments of the present disclosure provide a system 100 that can be integrated into a new trailer (e.g., 204) by an (OEM), or be retrofitted to an existing product. Systems of the present disclosure may also be combined with other systems and technologies (e.g., telematics systems and/or smart trailer systems). Systems of the present disclosure provide for incorporation of enhanced or high conspicuity lighting and optical communication into a trailer whether the tractor or towing vehicle is so equipped or not.

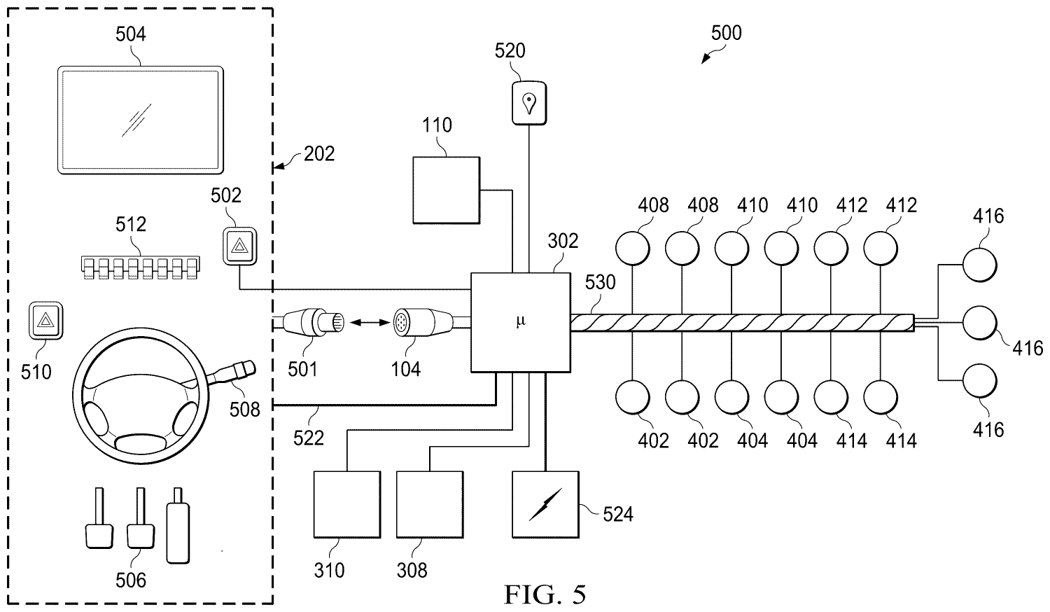

Referring now to FIG. 5, a simplified control schematic 500 of an emergency lighting an optical communication system according to the present disclosure interfaced to a semi tractor 202 for controlling trailer lighting is shown. The diagram 500 does not illustrate every possible light, input, or control but illustrates the microcontroller 302 receiving inputs from the tow vehicle or tractor (shown schematically by broken line 202) and “passing through” control inputs to the lights 402, 404, 406, 408, 410, 412, 414, 416. The microcontroller 302 may connect to a trailer lighting harness 530 providing individual leads to power and illuminate the respective lights. In some embodiments, the microcontroller 302 may interface with the various lights via a light controller (e.g., 304 as shown in FIG. 3). Via the tractor light source interface 104 (possibly connected to a matching interface 501 on the tractor 202) power and/or activation signals corresponding to activation of the trailer lighting may be provided to the microcontroller 302. Such signals may correspond to illumination of marker or parking lights, brake lights, signals lights, and others.

Lighting operation may also be supplemented or augmented with strobing or other high conspicuity operations as described herein. It should be understood that any light under control of the microcontroller 302 can be deployed in a high conspicuity or strobing manner. High conspicuity lighting can be activated by a number of methods, the effect of which is explained more fully below. The microcontroller 302 can take as input brake light signals from a press of a brake pedal 506, a turn indication from turn signal stalk 508, hazard flasher activation from a hazard flasher switch 510, maker light activation from a switch bank 512, activation of high conspicuity lighting from a separate switch 502 (or activation of high conspicuity lighting from sequential presses of the hazard flasher switch). The microcontroller 302 may communicate wirelessly with a tablet 504 or other personal communication device (e.g., a laptop or cell phone) inside or outside the tractor 504 to receive high conspicuity activation commands. High conspicuity activation may also come from the telematics interface 110 and may be the result of activation from a dispatch or other centralized office.

In some cases, it may be desirable to have access to more information from and about the towing vehicle or tractor 202 than can be provided via the tractor light source interface. In such case a data bus 522 may be provided (wired or wirelessly) allowing the microcontroller to be informed as to the engine speed or status, transmission gear or selector status, anti-lock braking system (ABS) deployment, airbag deployment and other information that may be available about the state or operation of the tractor 202. The interface or bus 522 may be a J1939 connection, a CANBUS connection, or other known interface.

Various embodiments of the present disclosure provide for the lights on or associated with a trailer to strobe or otherwise operate in an enhanced or high conspicuity manner. In some embodiments, such lights are those lights required by law or otherwise commonly provided on trailers (e.g., as shown in FIG. 4). Lights operable by and with the current system 100 include, without limitation, include marker lights, clearance lights, parking lights, tail lights, brake lights, signal lights, and backup or reverse lights. In some embodiments, each light maintains its original function but, in certain instances, may be operated at higher flash rate or in another matter that is visibly and observably distinct from the normal or typical operation of such light.

Some trailer lights are normally operated in a steady on or steady off state (e.g., marker lights). Others (e.g., signal lights) may normally be made to flash at a rate of somewhere around 1-2 Hz (as required by 49 CFR § 571.108, SAE standards, etc.). In various embodiments, when deployed according to methods and systems of the present disclosure, lights have an on/off cycle of about 4 Hz or more and may be referred to herein as functioning as a strobe rather than a flash. Other embodiments may have higher or slower strobe rates. In some embodiments, a strobe rate is any rate that is perceptibly faster than a signal light rate (e.g., the rate required by relevant regulations). In this manner, it is apparent to observers that an event other than a turn or a normal hazard light flash is being indicated by the trailer. Strobing operation may also be considered a particular case of high conspicuity operation.

Strobe alerts may also be generated that have a repeating cycle that strobes during only part of the illumination or strobes only during part of a larger cycle that may repeat at a slower rate. In one example, lighting may include a period of strobing, followed by a period of flashing or non-illumination, and then repeating. In another example, strobing or high conspicuity lighting may include periods of bright illumination interspersed with periods of lower illumination. The cycle of the bright and/or lower illumination may occur at a strobing rate (e.g., 4 Hz or more).

In some embodiments, the strobing pattern of lights on the left of the trailer may be out of phase or otherwise operated differently than those on the right to create a left-to-right or right-to-left effect (e.g., to direct traffic to one side or the other). These examples represent additional modes of high conspicuity operation. As lights oriented toward the front of the trailer (e.g., 402), middle (e.g., 404) and rear of the trailer (e.g., 408, 410, 412, 414, 416) may be under specific and individual control of the microprocessor, front-to-rear or rear-to-font signaling may also be effected. This may be useful when it is determined by GPS, accelerometer, or other data that the trailer 204 is no longer aligned with the roadway and front-to-back or back-to-front signaling may be more effective. Similarly, lights near a top of the trailer (e.g., 402, 404, 414, 416) can be differentiated from lights near a lower part of the trailer (e.g., 406, 408, 410, 412) for separate signaling, including, without limitation, bottom-to-top or top-to-bottom. The lights other than the signal light/hazard signal lamps (e.g., 402, 404, 406, 410, 412, 414, 416) may be strobed in coordination with signal lamps or hazard lamps (e.g., 408) or in alternating patterns to improve visibility, signal severity of the event, or indicate recommended direction of approach for oncoming traffic.

Any trailer or other towed vehicle may be equipped or retrofitted with systems and methods of the present disclosure. Such trailers include, without limitation, dry van trailers, flatbed trailers, refrigerated trailers (reefers), tank trailers, lowboy trailers, drop deck trailers (step deck trailers), curtain-side trailers, and livestock trailers.

In some embodiments, lights on the trailer (e.g., 204) that are designated as turn signals/hazard flashers (e.g., 408), will be strobed when it is determined that the tow vehicle 202 is indicating hazard lights. Such indication may arrive via the trailer light source interface 104 when it is determined by the microcontroller 302 that both left and right indicator lights are being activated simultaneously. Strobing may also occur if the tow vehicle 204 specifically indicates strobing of hazard lights (e.g., if the tow vehicle is equipped with an enhanced conspicuity lighting system). Strobing may also be activated manually by a switch (e.g., mechanical, electro-mechanical, or in/on a device screen) in the tow vehicle or via a wireless signal (e.g., Bluetooth®). Strobing or other high conspicuity operations may occur automatically as a result of the microprocessor 302 detecting certain events based on, for example, accelerometer data.

In some embodiments, the microprocessor is equipped with its own solid state accelerometer. In some embodiments, accelerometer or orientation data may be provided via motion control device 312. If acceleration, deceleration, overturns, or unexpected stoppages are detected by accelerometer or indicated in other data, the microprocessor may activate high conspicuity lighting without additional input. Where orientation and location of the trailer 204 can be detected, left-to-right or right-to-left high conspicuity operation of the trailer lights may commence automatically to guide oncoming traffic away from the back of the trailer. Global positioning system (GPS) data may be provided to the microprocessor via a dedicated GPS module 520 and/or via the telematics interface 110, wireless transponder 308, or Bluetooth® connection (possibly from tablet 504). This may be useful for determining the position of the trailer relative to the nearest roadway for purposes of determining left-to-right or right-to-left enhanced conspicuity light operation.

It will be appreciated that systems and methods of the present disclosure provide various modes of operation and various ways in which the system 100 can be activated. In some embodiments, strobing of the trailer turn signal lights (e.g., 408) may occur when the microcontroller 302 detects via the interface 104 to the tow vehicle that hazard flashers (e.g., both sides of signal lights 408) are deployed by the tow vehicle 202. In some embodiments, some or all of the other trailer lights may be strobed as well.

In some embodiments, the hazard lights may be flashed (e.g., operated at the typical rate, slower than strobing) when an accelerometer or other device detects that the trailer 204 is moving. When backup light data is available (e.g., the system 100 generally and the microcontroller 302 specifically, can detect that reverse lights are on), the system 100 may flash trailer lights 408 rather than strobe under the assumption that the trailer is being backed up under normal conditions (drivers are known to deploy flashers for safety when backing up, but such maneuver may not be suitable for strobing of tailer lights). Other nuisance prevention checks (e.g., to prevent strobing unless it is likely to be appropriate and needed) include, without limitation, having brakes set, GPS data confirming no movement, and air or electrical supply to the trailer being absent or diminished.

In some embodiments, systems of the present disclosure must be armed before trailer lights can be made to strobe (though flashing may be available as normal when the trailer 204 is connected to the tow vehicle 202). Arming may occur by a manual switch in the tow vehicle or elsewhere, by a remote signal received wirelessly (e.g., via Bluetooth®, phone network, etc.), based on location, or as a result of other input.

In embodiments where the tow vehicle 202 is equipped to selectively strobe or flash its own lights, the trailer 204 maybe operated in the same manner to match the tow vehicle 202. Such information may come from the tow vehicle 202 wirelessly or via a wired connection. Bluetooth® or other wireless protocols may be utilized.

Trailer strobing operations may also be triggered automatically based on information received in any manner from the tow vehicle 202 or from another appropriate source. Information indicative of a crash or other emergency state may be used to trigger trailer strobing. Such information may include, without limitation, ABS activation, airbag deployment, GPS data (e.g., vehicle off the roadway), engine or other vehicle failure, submersion, tire blowout or failure, or signals from a self-driving system (e.g., emergency stopping or shutdown). Again, such information or data may come from the tow vehicle wirelessly or via a wired connection. In some cases, information may be accessed via an OBDII port, via CANBUS, via J1939 connection or other means and provided wirelessly or via a wired connection to systems of the present disclosure.

In some embodiments, strobing may be activated or deactivated from a remote location (e.g., a dispatch office) based on broadcasting or otherwise wirelessly delivering a signal to the tow vehicle, trailer, telematics system, etc. In further embodiments, camera, microphone, and/or other data may be used to trigger strobing or nuisance prevention of strobing.

In some cases, an onboard accelerometer or other sensor(s) may infer emergency situations, such as rollovers and crashes, and trigger automatic deployment of trailer light strobing. Thus emergency trailer strobing does not strictly depend on a functioning tow vehicle or an intact electrical or data connection with the same.

In some embodiments, the strobing system 100 may be removable by the driver or user such that it can be moved or redeployed to another trailer. Such system may be beneficial where, for example, an operator may use a tow vehicle regularly with multiple trailers. Such embodiments may have a different physical configuration than shown and be configured as an “in line” device between the connection from the tow vehicle to the tailer. A magnetic housing or a housing with another mounting device to selectively and removably attach to the tow vehicle or trailer may be employed. In other embodiments, a base and/or connector may be built into the trailer to allow installation of the strobing system at the time of use, and normal trailer lighting functions otherwise.

Systems of the present disclosure may also be equipped with a battery backup system (524, FIG. 5). Thus strobing and other functions may be available even if the battery of the tow vehicle 202 fails or the tow vehicle 202 becomes disconnected from the trailer 204. In some embodiments, the system 100 may report wirelessly to a user or other monitoring operation when it has become disconnected from the trailer 204, when it becomes reconnected, the state of the backup battery, power supply, and other useful information. Startup testing and self diagnostic information may also be reported wirelessly or otherwise.

While the systems of the present disclosure may be separate systems to be installed on a trailer at the time of manufacture, or as a retrofit upgrade, it is also possible to incorporate functions of the present disclosure into other devices or mechanisms associated with the trailer. For example, if a telematics system or smart trailer system is present or desired, it may be possible to incorporate the telematics system or smart trailer system with systems of the present disclosure. Brake controllers, refrigerator controllers, inventory monitoring systems, tire pressure monitoring systems, and other systems desired or needed for a trailer may be combined with systems of the present disclosure to reduce duplication of parts and enhance functionality without commensurate increase in cost. In other embodiments, it may be desirable to keep lighting functionality separate for safety, security, or other reasons. In such case, it may still be acceptable or desirable to combine multiple devices into a single housing, reducing space and weight requirements.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system for a trailer comprising:
a microcontroller having a communicative coupling to a tow vehicle that receives light activation signals from the tow vehicle corresponding to a plurality of lights on the trailer including at least signal and hazard lights;
wherein the microcontroller has operative control over the plurality of trailer lights;
wherein the microcontroller strobes at least the hazard lights in response to a hazard light activation signal from the tow vehicle; and
wherein the strobing operation is perceptibly faster than a flashing operation that corresponds to operation of signal lights.

2. The system of claim 1, wherein the hazard lights comprise left and right signal lights on at least a rear of the trailer.

3. The system of claim 1, wherein, when the microcontroller strobes at least the hazard lights, it also strobes additional ones of the plurality of lights on the trailer.

4. A system for a trailer comprising:
an interface to a tow vehicle that provides power and activation signals corresponding to a plurality of lights on the trailer including at least signal and hazard lights;
an interface to the trailer that provides operative control over the plurality of trailer lights; and
a microcontroller that receives at least the activation signals from the interface to the tow vehicle and operatively controls the plurality of trailer lights via the interface to the trailer;
wherein the microcontroller strobes one or more of the plurality of trailer lights at a rate perceptible faster than a rate at which the microcontroller flashes a signal light in response to a strobe signal.

5. The system of claim 4, wherein the strobe signal is received from the tow vehicle.

6. The system of claim 5, wherein the strobe signal comprises a signal to activate left and right signal lights.

7. The system of claim 5, wherein the strobe signal is provided by an automated vehicle emergency system.

8. The system of claim 5, wherein the strobe signal is provided by a self-driving system.

9. The system of claim 4, wherein the signal is received wirelessly.

10. The system of claim 4, wherein the one or more of the plurality of trailer lights that is strobed includes the signal and hazard lights.

11. The system claim 10, wherein the one or more of the plurality of trailer lights that is strobed includes trailer lights in addition to the signal and hazard lights.

12. The system claim 4, wherein the microcontroller does not strobe the one or more of the plurality of trailer lights when a nuisance signal is also received.

13. The system claim 4, wherein the microcontroller is communicatively coupled to a telematics system for receiving the strobe signal.

14. The system claim 4, further comprising a housing affixed to the trailer and containing the microcontroller.

15. The system of any claim 4, further comprising a battery backup system connected to power at least the microcontroller.

16. The system of claim 4, wherein the interface to the tow vehicle comprises a first ISO1724 interface.

17. The system of claim 15, wherein the interface to the trailer comprises a second ISO1724 interface.

18. A system for a trailer comprising:
an interface to a tow vehicle that provides activation signals corresponding to a plurality of lights on the trailer including at least left and right signal lights;
an interface to the trailer that provides operative control over the plurality of trailer lights; and
control logic that receives the activation signals from the interface to the tow vehicle and operatively controls the plurality of trailer lights via the interface to the trailer;
wherein the control logic flashes the left signal light when receiving a left signal light activation signal and flashes the right signal light when receiving a right signal light activation signal;
wherein the control logic strobes the left signal light and the right signal light simultaneously when the control logic receives a strobing activation signal;
wherein the strobe rate is perceptibly faster than the left signal light rate and the right signal light rate.

19. The system of claim 18, wherein the strobing activation signal comprises a hazard light activation signal.

20. The system of claim 18, wherein the strobing activation signal comprises a signal distinct from a hazard light activation signal.

21. The system of claim 18, further comprising a battery backup that operates the control logic and the left and right signal lights when insufficient power is received from the interface to the tow vehicle.

22. The system of claim 18, wherein when the control logic strobes the left signal light and the right signal light simultaneously when the control logic receives a strobing activation signal, the control logic strobes additional ones of the plurality of lights on the trailer.
